(19) United States
(12) Patent Application Publication
(10) Pub. No.: US 2021/0248521 A1
(43) Pub. Date: Aug. 12, 2021

(54) RESERVATION BUYING/SELLING SYSTEMS AND METHODS

(71) Applicant: SecretLab, LLC, Minneapolis, MN (US)

(72) Inventor: Jason BRIGHT, Minneapolis, MN (US)

(21) Appl. No.: 17/179,905

(22) Filed: Feb. 19, 2021

Related U.S. Application Data
(63) Continuation of application No. 16/293,296, filed on Mar. 5, 2019, now abandoned.
(60) Provisional application No. 62/651,483, filed on Apr. 2, 2018.

(51) Int. Cl. G06Q 10/02; G06Q 30/02

(52) U.S. Cl. CPC G06Q 10/02; G06Q 30/0206

(57) ABSTRACT

Reservation selling and/or buying systems and methods are described that provide a platform that allows users to buy and/or sell reservations using mobile devices. The systems and methods described herein also allow the buyers and sellers to complete a reservation sell/buy transaction by effecting payment from the buyer to the seller.

### FIELD

This technical disclosure relates to a platform to facilitate the automated selling and/or buying of reservations using mobile devices by individuals that have reservations with businesses and by individuals looking to acquire reservations with the businesses through individuals or through the businesses.

### BACKGROUND

A person with a reservation at a business may not be able to use the reservation or someone else may value that reservation more highly and may wish to acquire the reservation. In addition, a person's mobile device may contain a variety of data sources that indicate an actual or possible reservation beyond just a calendar system.

### SUMMARY

Reservation selling and/or buying systems and methods are described that provide a platform that allows users to buy and/or sell reservations using mobile devices. The systems and methods described herein also allow the buyers and sellers to complete a reservation sell/buy transaction by effecting payment from the buyer to the seller.

The reservation selling and/or buying systems and methods can be used with any reservation provided by a business that provides reservation based services. Examples of businesses with such reservations include, but are not limited to, restaurants, doctors, personal groomers such as hair dressers, massage therapists, and the like.

### DRAWINGS

FIG. 1 illustrates an example of a reservation selling and/or buying system described herein.

FIG. 2 is an example schematic depiction of a mobile device containing a reservation buy/sell application with a reservation mining system.

FIGS. 3A, 3B and 3C illustrate examples of systems on a mobile device from which reservations can be mined.

FIG. 4 is an example of a user interface screen on a seller's mobile device provided by the reservation buy/sell application.

FIG. 5 is an example of a process implemented by the mobile device.

FIG. 6 is an example of a user interface screen on a buyer's mobile device provided by the reservation buy/sell application.

FIG. 7 illustrates an example of a process performed by the server based upon a request sent from the buyer's mobile device.

FIG. 8 illustrates an example of a reservation buying process that is performed when a buyer attempts to buy a reservation from the seller.

FIG. 9 illustrates an embodiment of a reservation selling and/or buying system that is similar to the system in FIG. 1 but also includes an artificial intelligence system.

### DETAILED DESCRIPTION

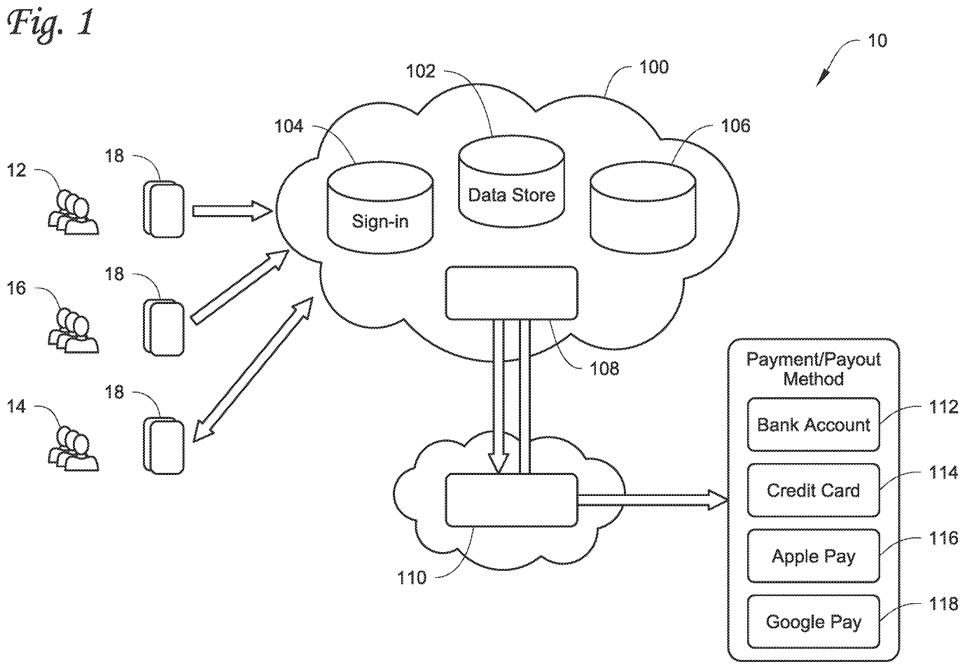

FIG. 1 illustrates an example of a reservation selling and/or buying system 10 (hereinafter “the system” 10 or the like). The system 10 provides a platform that allows an individual (hereinafter referred to as a seller 12 or the like) having a reservation at a business to sell the reservation to another person (hereinafter referred to as a buyer 14 or the like). The system 10 can also allow a business 16 that has an open reservation to offer the reservation to an interested buyer 14. The system 10 creates an exchange where sellers 12 and businesses 16 can offer their reservations for sale to buyers 14, where buyers 14 can make offers to buy the reservations, and where the purchase can be completed and payment rendered to the sellers 12 or businesses 16.

The system 10 creates and manages a list of reservations that are available for purchase. Reservations can be added to the list from the sellers 12, and the buyers 14 can make bids on reservations that they wish to acquire. If a reservation buy and sell agreement is reached, the system 10 also manages payment from the buyer to the seller.

As used throughout this description and claims, a reservation available for sale is a reservation that has not yet taken place or has not yet expired i.e. the reservation occurs at some point in time in the future. The reservation could be minutes, hours, days, weeks or months in the future. There is no limit on how far in the future the reservation is set for. However, in some embodiments, the seller 12, the buyer 14 and the business 16 may be able to set a user-defined limit as to how far in the future a reservation can be to be included in the system 10.

The reservation (which may also be referred to as a business reservation) can be for any business that provides reservation based services. Examples of businesses with such reservations include, but are not limited to, restaurants, doctors, personal groomers such as hair dressers, massage therapists, and the like. The description that follows, and the examples below and in the drawings, will assume that the reservation is for a restaurant. However, the concepts described herein are not limited to restaurant reservations unless explicitly limited by the language in the claims.

The seller 12, the buyer 14 and the business 16 interact in the system 10 using mobile devices 18. Examples of the kind of mobile devices 18 that can be used include, but are not limited to, mobile phones and tablets (including but not limited to iOS and Android based devices), and wearable devices such as watches, glasses and the like.

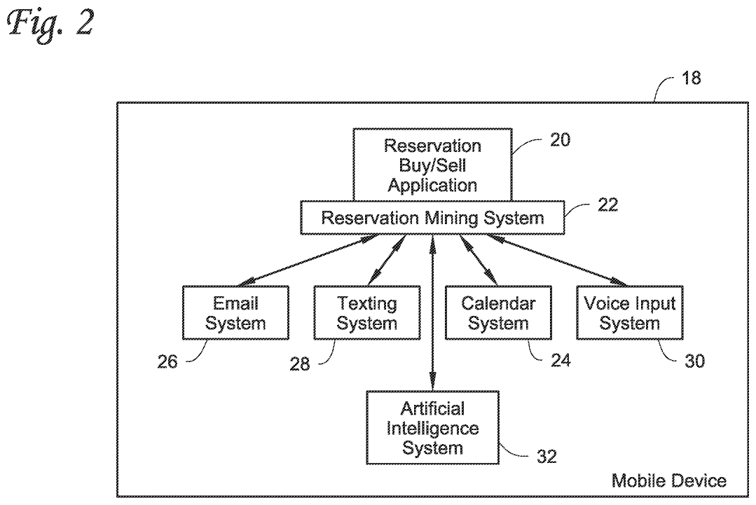

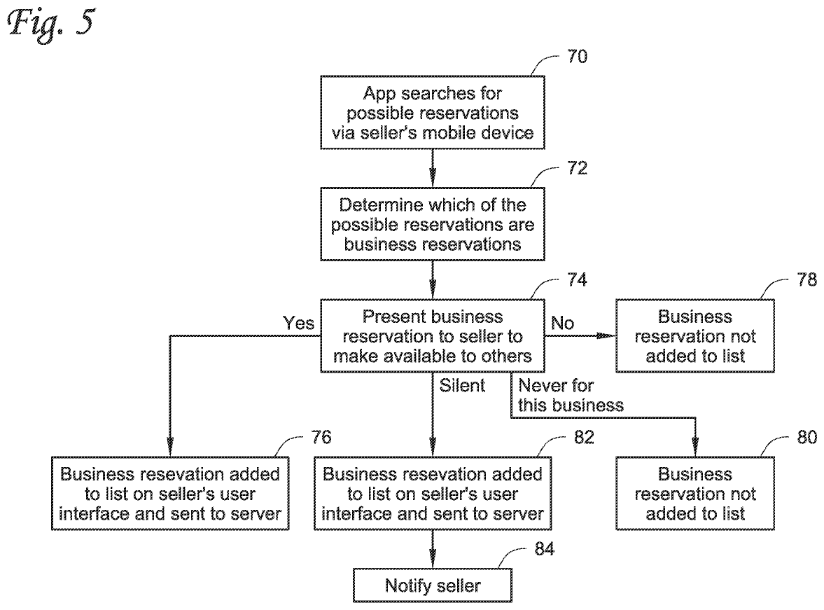

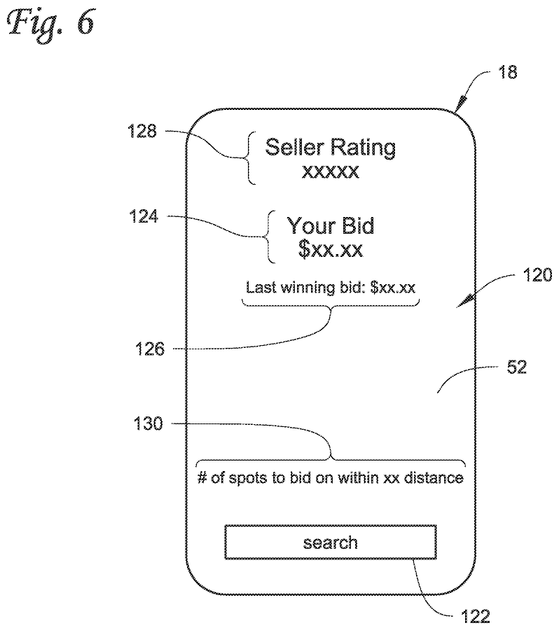

FIG. 2 schematically depicts an example of the mobile device 18. The mobile device 18 includes a reservation buy/sell application 20 loaded thereon that forms the interface for the seller 12, the buyer 14 and the business 16 with the system 10. The mobile device 18 also includes a user interface screen (seen in FIGS. 5 and 6) on which a user interface can be displayed by the application 20, a microphone (not shown) to allow voice or audio input into the voice input system 30, and one or more data input devices that allow manual data input into the mobile device 18 and the application 20 running thereon. The data input device(s) can be any conventional data input device known in the art, such as a touch sensitive keypad displayed on a touchscreen, a mechanical keypad, or one or more input buttons. The mobile device 18 is also powered by one or more rechargeable batteries and is portable.

From the perspective of the seller 12, the application 20 uses a reservation mining system 22 that looks for, for example all past, present and/or future restaurant reservations and appointments on the seller's mobile device 18. The mining system 22 can interface with one or more systems on the mobile device 18 in an effort to find a reservation of the seller 12. For example, the mining system 22 may interface with and obtain reservations from one or more of the following: a calendar system 24 on the mobile device 18; an email system 26 on the mobile device 18; a texting system 28 on the mobile device 18; a voice input system 30 on the mobile device 18; or an artificial intelligence system 32 on the mobile device 18. The mining system 22 reviews one or more of these systems 24-32 looking for data that may indicate a possible reservation. Of the possible reservations that are found, the mining system 22 then determines which of the reservations are business reservations and which are miscellaneous or ineligible appointments. In addition to using the mining system 22 to scour the mobile device 18 for reservations, the application 20 may also be configured to allow the seller 12 to directly input a reservation via the application 20.

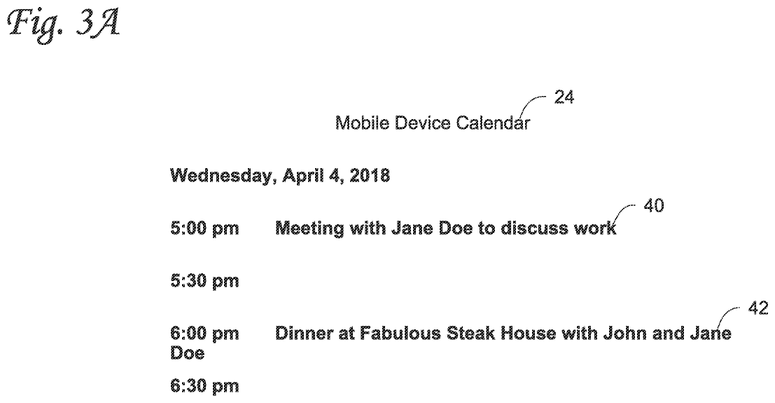

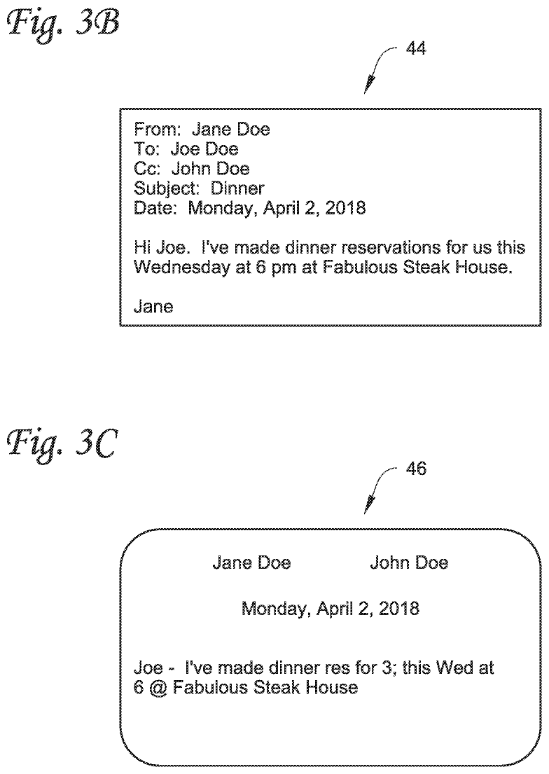

FIG. 3A illustrates an example of the calendar system 24 on the mobile device 18. The calendar system 24 is conventional and similar to calendar systems in use on mobile devices at the time of filing this application. The calendar system 24 allows a user to enter reservations and other appointments on desired days and times selected by the user. The calendar system 24 will likely be the first of the systems 24-32 scoured by the mining system 22 when looking for reservations.

In the example of FIG. 3A, the calendar system 24 is illustrated as including two reservations, for example scheduled on Apr. 4, 2018, one reservation 40 at 5:00 pm and another reservation 42 at 6:00 pm. The mining system 22 will scour the calendar system 24 and locate each reservation 40, 42. The mining system 22 will then determine, using suitable logic and analysis of available data, whether either of the reservations 40, 42 is an eligible restaurant or other business reservation.

For example, the reservation 40 uses the terms “Meeting” and “discuss work” which suggest a business meeting rather than a restaurant reservation. Likewise, the time of the meeting (i.e. 5:00 pm) could also be an indicator of a non-restaurant reservation. However, the seller 12 may in the past have 5:00 pm restaurant reservations which could weigh in favor of the reservation 40 being a restaurant reservation. The reservation 40 also refers to Jane Doe which, if the seller has never had dinner with this person, could indicate that the reservation 40 is not a dinner reservation. The mining system 22 will consider all of this data and judge whether or not the reservation 40 is an eligible reservation. In this example, the mining system 22 would determine that the reservation 40 is not an eligible reservation.

However, when the mining system 22 analyzes the reservation 42, the reservation 42 mentions the name Fabulous Steak House as well as mentions the word dinner. Each of these strongly suggests that the reservation 42 is a restaurant reservation. In addition, the mining system 22 will cause the mobile device 18 to automatically connect to a business look up system, such as Google My Business, and if the business name mentioned in the reservation 42 is found in the business look up system, that would suggest an eligible restaurant reservation. The mining system 22 will consider all of this data and judge whether or not the reservation 42 is an eligible reservation. In this example, the mining system 22 would determine that the reservation 42 is an eligible reservation.

Similarly, FIG. 3B illustrates an example of an email 44 from the email system 26 on the mobile device 18. The email system 26 is conventional and similar to email systems in use on mobile devices at the time of filing this application. The email system 26 allows a user to send and receive emails, the contents of which could indicate the existence of a reservation that has not been entered into the calendar system 24. The email 44 in FIG. 3B can be an email that has been received by the seller 12 and the email 44 can be contained in any folder of the email system 26 including, but not limited to, the inbox folder, the deleted items folder, or the trash folder of the email system 26, or the email 44 can be an email that has been sent by the seller 12 and the email 44 can be contained in any folder of the email system 26 including, but not limited to, the sent items folder, the deleted items folder, or the trash folder of the email system 26.

The email 44 contains the standard sender and recipient information, subject line, and date. In this example, the subject line refers to “Dinner” which could indicate a dinner reservation. The body of the email 44 also refers to “dinner reservations”, a time and day of the reservation, and the location Fabulous Steak House, each of which suggest a restaurant reservation. In addition, the mining system 22 will cause the mobile device 18 to automatically connect to a business look up system, such as Google My Business, and if the business name mentioned in the email 44 is found in the business look up system, that would suggest an eligible restaurant reservation. The mining system 22 will consider all of this data and judge whether or not the email 44 contains an eligible reservation. In this example, the mining system 22 would determine that the email 44 is referring to an eligible reservation and that reservation would be pulled into the system 10.

Similarly, FIG. 3C illustrates an example of a text 46 from the texting system 28 on the mobile device 18. The texting system 28 is conventional and similar to texting systems in use on mobile device's at the time of filing this application. The texting system 28 allows a user to send and receive texts, the contents of which could indicate the existence of a reservation that has not been entered into the calendar system 24. The text 46 in FIG. 3C can be a text that has been received by the seller 12, or the text 46 can be a text that has been sent by the seller 12.

The text 46 contains the standard sender and recipient information and date. In this example, the body of the text 46 also refers to “dinner res”, a time and day of the reservation, and the location Fabulous Steak House, each of which suggest a restaurant reservation. In addition, the mining system 22 will cause the mobile device 18 to automatically connect to a business look up system, such as Google My Business, and if the business name mentioned in the text 46 is found in the business look up system, that would suggest an eligible restaurant reservation. The mining system 22 will consider all of this data and judge whether or not the text 46 contains an eligible reservation. In this example, the mining system 22 would determine that the text 46 is referring to an eligible reservation and that reservation would be pulled into the system 10.

The mining system 22 may also obtain an eligible reservation via the voice input system 30. For example, the seller 12 may speak into the microphone of the mobile device 18 and verbally input a reservation into the application 20. In some embodiments, the mining system 22 may also rely upon ambient noise or voices picked up by the microphone of the mobile device to determine that the seller has a reservation to be included.

The mining system 22 may also obtain an eligible reservation via the artificial intelligence (AI) system 32. For example, the AI system 32 may track the seller's location over time using the GPS capabilities of the mobile device 18 and determine that at regular days and times the seller 12 is at a location corresponding to a particular restaurant. The AI system 32 can use this information to determine that a reservation for that particular restaurant exists and should be included. The AI system 32 can also communicate with the systems 24-30 to help analyze the available data to make a determination whether or not an eligible reservation exists.

Returning to FIG. 2, any possible reservation uncovered by the mining system 22 is then presented to the seller 12 via a user interface of the application 20. The seller 12 is presented with three options: 1) make the reservation available to others by listing the reservation for sale; 2) do not make the reservation available to others and do not list the reservation for sale; and 3) never make any reservations for this particular business available to others or list the reservation for sale. Accordingly, if one of the reservations uncovered by the mining system 22 is not actually a restaurant reservation or if the seller 12 does not wish to sell the reservation, the application 20 provides the seller 12 the ability to prevent the reservation from being listed for sale.

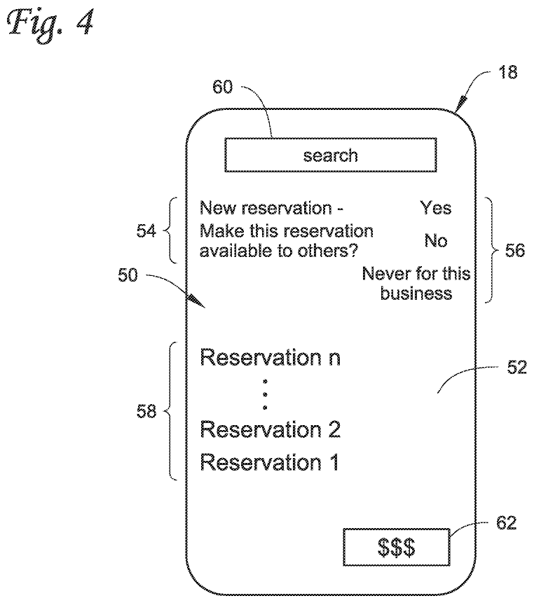

FIG. 4 illustrates an example of a user interface 50 of the application 20 that is presented to the seller 12 on a display screen 52 of the mobile device 18. The user interface 50 displays each reservation 54 uncovered by the mining system 22 and presents to the seller 12 the three options 56. The seller 12 can select “Yes” if the seller wishes to make the reservation available to others by listing the reservation for sale. The seller 12 can select “No” if the seller does not wish to make the reservation available to others and the reservation not be listed for sale. The seller 12 can select “Never for this business” (or the like) if the seller never wants to make any reservations for this particular business available to others or list any reservations for this business for sale.

In some instances the seller 12 may not make an affirmative decision by selecting one of the three options 56. If this occurs, the application 20 may be configured to cause the reservation to be automatically listed for sale in the system 10. An alert may also be provided to the seller 12 notifying the seller 12 that the reservation has been listed for sale, and in some embodiments providing the seller 12 the option to remove the reservation. The alert can be in one or more of the following forms: causing the mobile device 18 to vibrate, emit a distinctive sound, and/or display data or a graphic on the display of the mobile device 18. Further, as described in more detail below, if a buyer 14 makes an offer or bid on the listed reservation in this scenario, the seller 12 will also be alerted or provided a notice and the seller 12 is provided the chance to accept the offer, make a counter-offer, deny the offer, or remove/delist the reservation.

For each reservation for which the seller 12 selects “Yes” or for which the seller does not make a selection and the reservation is automatically listed, the application 20 adds the reservation to a list 58 of reservations displayed on the user interface 50. The list 58 may also display prior reservations that have been sold to buyers and/or the status of each pending reservation and whether any bids have been received for each reservation. The user interface 50 can also provide a search field 60 that allows the seller to conduct a search for restaurants, prior reservations in the list 58, and other searchable data.

FIG. 5 illustrates an example of a process implemented by the mobile device 18 of a seller 12 involving reservation mining and listing described above. At box 70, the mining system 22 of the application 20 searches for possible reservations via the mobile device 18 as described above. At box 72, the application 20 then determines which of the located reservations are eligible reservations (or business reservations). At box 74, the eligible/business reservations are then presented to the seller 12 via the user interface 50 with the seller 12 presented the options 56. If the seller 12 selects “yes”, the process proceeds to box 76 where the reservation is added to the list 58 on the user interface 50, and the reservation is sent to a server 100 (described further below) of the system 10 to make the reservation available to a buyer 14. If the seller 12 selects “no”, the process proceeds to box 78 and the reservation is not added to the list 58 on the user interface 50 and the reservation is not sent to the server 100. If the seller 12 selects “Never for this business” or the like, the process proceeds to box 80 and going forward no reservations for that restaurant are presented to the seller 12 so that the reservations are never added to the list 58 and never sent to the server 100 until such time that the seller 12 affirmatively removes the “Never for this business” selection. If the seller 12 does not make an affirmative decision, i.e. is silent and does not select one of the options 56, the process proceeds to box 82 where the reservation is added to the list 58 on the user interface 50, and the reservation is sent to the server 100. In addition, at box 84, a notice(s) is sent to the seller's mobile device 18 as described above to notify the seller 12 that the reservation has been sent to the server to present to possible buyers 14.

Returning to FIG. 1, the system 10 includes the server 100 which collects and stores the various reservations that are available for sale, and presents the reservations to the buyers 14. The server 100 can be disposed in one location, or the functions thereof can be distributed among various locations. In the illustrated example, the server 100 includes a data storage 102 that stores the data relating to the various reservations that are available for purchase, and an access module 104 that controls sign-in/log-in functionality between the mobile devices 18 and the server 100. The server 100 can also include a business search module 106 that functions as a data repository of businesses and business names that can be searched, and functions as a communication gateway to the internet to search for businesses. The data that is stored in the module 106 can be continually added to by adding information on businesses already stored in the module 106, and adding additional businesses and business information as users (sellers 12, buyers 14, and businesses 16) of the system 10 refer the various businesses while using the system 10. The server 100 also includes a communication module 108 that controls communications with a payment processor 110 that controls payments from a buyer's account to a seller's account. Any form of payment can be used including, but not limited to, to/from a bank account 112, to/from a credit card 114, or a mobile device based payment and digital wallet service using Apple Pay 116 or Google Pay 118.

The application 20 also allows a buyer 14 to bid on and buy reservations that are available for purchase from sellers 12. Upon launching the application 20 on the mobile device 18, the user can make a selection presented to the user to launch a buy user interface 120 on the display screen 52. An example of the buy user interface 120 is illustrated in FIG. 6. The buy user interface 120 provides a search field 122 that allows the buyer 14 to search the server 100 for available reservations. The search could be based on the restaurant name by entering the name in the search field 122. Filters or other search criteria can also be used, such as searching for all reservations on a particular day and/or time at any restaurant within a desired distance from the user's location or other location. The search results would be displayed on the buy user interface 120 in a list. The search results could be ordered, for example by most recent available reservation at the selected restaurant, by the number of seats available with each reservation, by the listed price of the reservation, or by any other criteria. For each reservation, information on a minimum bid amount (if any) set by the seller 12 is also listed. The list on the buy user interface 120 may also display prior reservations purchased and/or bid on by the buyer 14.

For each available reservation, a select feature is provided on the buy user interface 120 that allows the buyer 14 to select a desired reservation. Upon selecting one of the reservations, the buy user interface 120 will provide a bid field 124 that allows the buyer 14 to enter a bid for that reservation. The buy user interface 120 can also display the last winning bid 126 for a reservation at that restaurant, which provides the buyer 14 some indication of how competitive the buyer's bid may be when compared to a prior winning bid. In addition, the buy user interface 120 can also display a seller rating 128 which is a rating of the seller 12 that is selling the reservation based on data such as the seller's past selling and buying history using the application 20, ratings and comments from buyers who have purchased reservations from the seller, and other data. The buy user interface 120 may also contain a display 130 that indicates the number of reservations that can be bid on where the current holders of those reservations are within a predetermined distance of the restaurant based on GPS coordinates. The purpose of the display 130 will be described below.

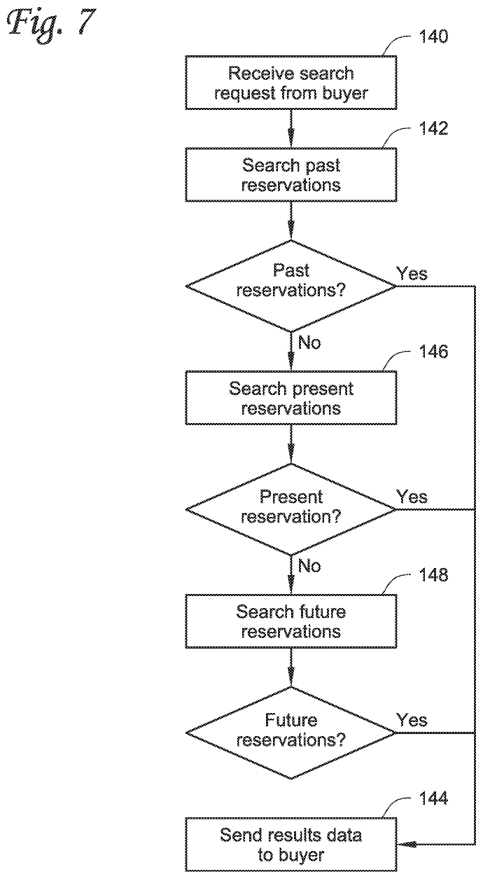

Referring to FIG. 7, when the buyer 14 executes a search for an available reservation the server 100 executes the following routine. Reservations are always for future events. However, the terms “past”, “present” and “future” reservations used herein refers to the seller's action(s) of approving a sale and/or listing a reservation for sale. For example, a “past reservation” means a reservation from a seller 12 that has been previously added to the data storage 102 and where the seller 12 has pre-approved the action of selling the reservation at a predetermined sale price before the requested reservation time by the buyer 14 before the buyer exists so that the transaction is completed without interaction with the seller as long as the buyer's bid for the reservation meets or exceeds the seller's predetermined sale price. A “present reservation” means that the seller interactively approves a sale with a buyer whereby a message is sent to the seller's mobile device 18 with the buyer's bid inquiring whether the seller wishes to accept the bid. A “future reservation” means that the buyer uses the system 10 to ask to buy a reservation that is not yet in the system 10 in which case the buyer is hoping for a future seller.

In the routine in FIG. 7, at box 140 the server 100 receives the search request transmitted from the buyer's mobile device 18. At box 142, the server 100 then searches for any past reservations in the data storage 102 that meet the search criteria. If a past reservation is located, the process then proceeds to box 144 and the results are presented to the buyer 14 listing the available past reservations. The buyer 14 can then select the desired reservation and the payment transaction can then be immediately completed.

If a past reservation is not located, the process then proceeds to box 146 where the server 100 determines if there are any present reservations that may be available. A present reservation is a possible reservation that is not contained in the data storage 102, but is indicated by other data suggesting the possible availability of a reservation. For example, a seller may have a reservation but has not chosen to list the reservation for possible sale; or using the GPS coordinates of seller's mobile devices 18, the server 100 may determine that one or more seller's 12 having the application 20 loaded on their mobile devices 18 may be waiting in line at the restaurant and at or near the time of the buyers 14 request. This is the number listed in the display 130 of FIG. 6. Because the sellers are waiting in line, this may indicate that the sellers have a reservation at the restaurant and the time requested by the buyer. If a present reservation is found, a message is sent to the mobile device 18 of the seller(s) waiting in line asking whether the seller is interested in selling their reservation. If the seller answers “yes”, a message is sent to the buyer's mobile device 18 indicating the availability of a reservation, and prompting the buyer to submit a bid. If the bid is ultimately accepted by the seller, the payment transaction is completed, and the buyer is provided the name of the seller to allow the buyer to appear at the restaurant and claim the reservation.

If a present reservation is not located, the process then proceeds to box 148 where the server 100 determines if there are any future reservations that may be available. A future reservation is a reservation at the restaurant selected by the buyer 14 that is not currently listed or visible in the system 10, but may be listed by a new update by a seller. In this case the buyer 14 may use the system 10 to list an offer to buy a reservation fitting their criteria (for example, day, time, location, number of available seats, etc.), and a seller 12 may or may not respond to the offer by listing a reservation they may have. Alternatively, the system 10 may continue searching for a future time period for a reservation meeting the buyer's criteria. The future reservations (if any) are, upon discovery, presented to the buyer 14 via the buy user interface 120 allowing the buyer 14 to bid on the reservation.

A simple example of past, present and future reservations is as follows. A buyer 14 would like to go to restaurant “A” Tuesday evening sometime. There are no reservations meeting these criteria that have already been marked by a seller as sellable (past reservation). The system 10 then contacts participants in the system that could have an available reservation (present reservation). Upon elapse of a predetermined maximum wait time, the system 10 queries the buyer 14 asking if the buyer 14 would like to continue searching for a reservation for up to a future listing time period (for example, 24 hours) in the future (future reservation). In the future, for example three hours in the future, an appointment is found matching the buyer's request. The buyer 14 is alerted and can then bid on the reservation.

If no past, present or future reservations are available, and the future listing time has elapsed, a message to that effect is sent to the buyer's mobile device and displayed on the user interface 120 informing the buyer 14 of the unavailability of a compatible reservation.

Returning to FIG. 6, when the buyer 14 finds a reservation the buyer is interested in bidding on and buying, the buyer 14 enters a bid in the bid field 124 and hits send. The bid is then sent to the server 100. If the reservation is one that the seller 12 intentionally listed by selecting the “yes” option (see FIG. 5) and the bid meets the minimum sell price established by the seller, the bid is automatically accepted and the payment processor 110 then completes the transaction by transferring funds from the buyers account 112-118 to the sellers account 112-118. The buyer is then provided the name the reservation is held under, allowing the buyer to appear at the restaurant at the appropriate time to claim the reservation.

However, as described above, in some instances a reservation (such as a past reservation) may be automatically listed in the system 10 if the seller 12 is silent (i.e. does not make an affirmative selection of one of the options 56 in FIG. 4). In these instances, if the buyer 14 submits a bid, an alert is sent to the seller 12 notifying the seller that someone is interested in purchasing the seller's reservation, and the amount of the bid. The seller 12 can ignore the alert in which case the reservation is not sold to the buyer 14. If the seller 12 is interested in selling the reservation, the seller can respond back accepting the bid or submit a counteroffer which is sent to the buyer.

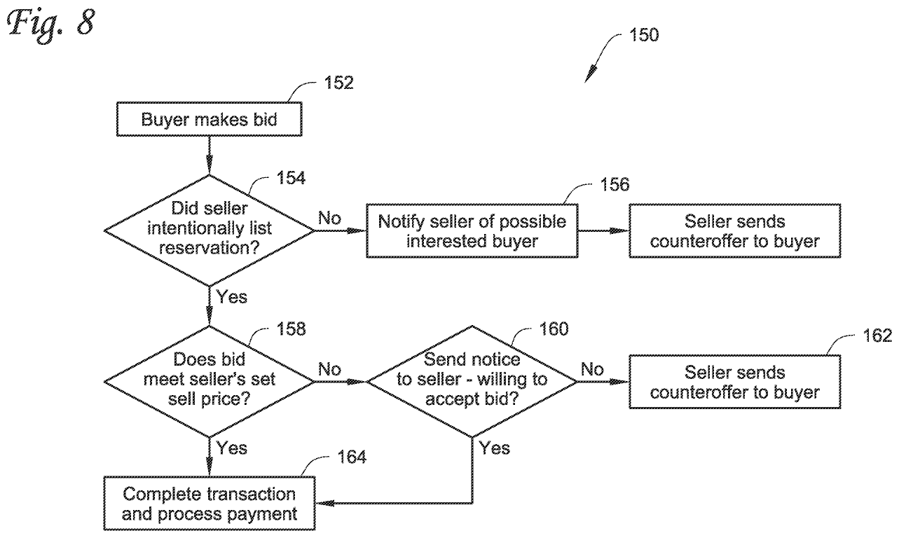

FIG. 8 illustrates an example of a reservation buying process 150 that is performed when a buyer 14 attempts to buy a reservation from a seller 12. At box 152, the buyer submits a bid to the server 100 as described above with respect to FIG. 6. At box 154, the server 100 then determines whether or not the seller intentionally listed the reservation by selecting the “yes” option 56 (FIG. 4). If the determination at box 154 is no, the process 150 proceeds to box 156 where the server 100 sends notice to the seller that someone is interested in purchasing the reservation. The seller can then agree to sell the reservation and/or send the buyer a counteroffer, or not respond in which case the reservation is not sold. If the determination at box 154 is yes, the process 150 proceeds to box 158 where the server determines whether or not bid meets the seller's set sell price. If the determination at box 158 is no, the process 150 proceeds to box 160 where the server 100 sends notice to the seller asking whether or not the seller is willing to accept the bid. If no, the seller can send a counteroffer 162 to the buyer. If the determination at box 158 is yes or if the determination at box 160 is yes, the process proceeds to box 164 where the server 100 completes the transaction by completing the payment using the payment processor 110.

Returning to FIG. 1, the restaurants 16 (or other businesses) can also be participants in the system 10. The restaurants 16 may have reservations that are available and that they wish to present to users of the system 10. In this instance, the restaurants 16 become sellers 12 and can sell their available reservations in a manner similar to the other sellers described above. In addition, the restaurants 16 can create and upload coupons, discounts, offers, advertising, announcements and other promotional materials, with or without limited time durations, to the server 100 for distribution to users of the system 10.

In one embodiment, the reservation selling and/or buying transactions described herein can be insured. The seller and/or the buyer can be provided the ability if they so choose to insure the transaction for a fee. Insuring the transaction by either party may be useful to help provide assurance that either party will be made whole if the other party engages in a sham transaction. The cost of the insurance to either party can be a flat fee or the cost can be variable based upon their seller rating 128 and/or other factors such as data gleaned from social networks, such as Facebook or the like, to which the party belongs.

In addition, in another embodiment, the system 10 can allow a user of the system 10 to send out a request to other users of the system 10 to make a specific reservation on their behalf or to stand in line at a restaurant or other business for them (i.e. line waiting). This embodiment would be especially useful for a remote or “out-of-town” user to send a request to a local user. The user sending out such a request may be required to pay a fee to the responding user for their time and effort. The fee could be a flat fee or the fee could be negotiable between the two parties.

In another embodiment, geolocation can be used to offer goods and services to users of the system 10. For example, the system 10 can monitor the locations of the users having the application 20 using the GPS features on the mobile devices 18. Based on the GPS coordinates, when one of the users is determined by the server 100 to be near a restaurant or other business participating in the system 10, the server 100 can send promotional materials, such as an offer for goods or services, for the restaurant or other business to the user's mobile device 18. The promotional materials could go away after a period of time and/or if the user moves far enough away from the restaurant or other business.

In another embodiment, if more than one buyer 14 bids on the same reservation, an auction system can be automatically established by the server 100. In such an auction system, the buyers 14 would be given a period of time to bid against one another for the reservation. At the end of the period of time, the buyer with the largest bid is considered the winner, and the transaction can be completed as discussed above.

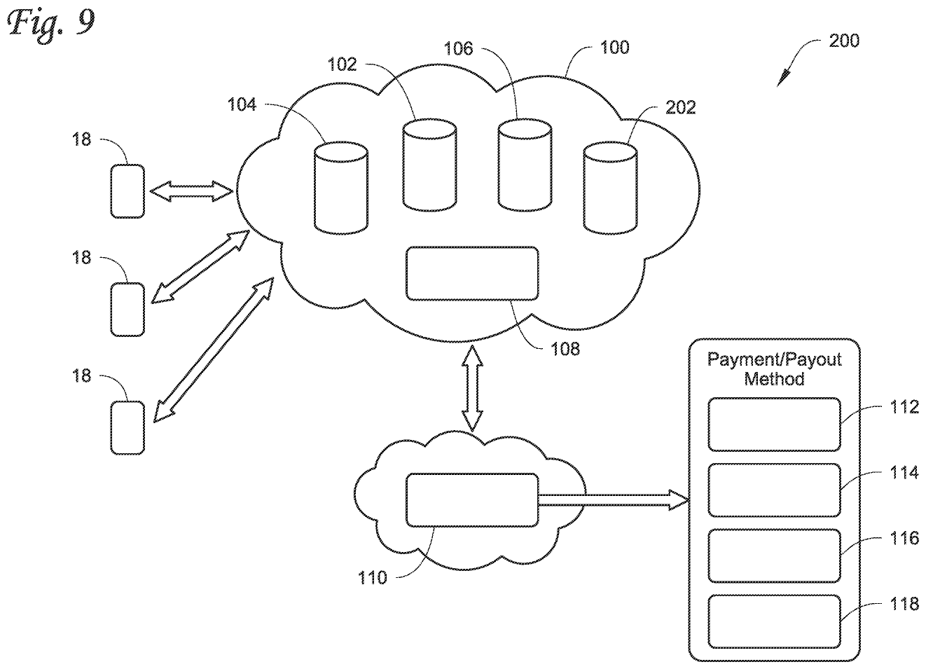

FIG. 9 illustrates another embodiment of a reservation selling and/or buying system 200. The system 200 in FIG. 9 is illustrated as being similar to the system 10 illustrated in FIG. 1 and elements in the system 200 that are in common with elements in the system 10 are referenced using the same reference numerals. However, the system 200 need not be similar to the system 10.

The system 200 in FIG. 9 differs from the system 10 in that the system 200 includes an artificial intelligence (AI) system 202. The AI system 202 is illustrated as being included within the server 100. However, the AI system 202 can be separate from the server 100. In addition, the AI system 202 can be incorporated into the system 10.

The AI system 202 can be configured to make telephone calls relating to the selling and/or buying of reservations. Examples of such telephone calls can include, but are not limited to: the AI system 202 can make telephone calls to one or more businesses on behalf of a buyer or seller to verify reservations/appointments of either the buyer or the seller; the AI system 202 can make telephone calls to one or more businesses on behalf of a buyer or seller to determine if there are any cancelled reservations/appointments; the AI system 202 can make telephone calls to one or more businesses on behalf of a buyer or seller to make a reservation/appointment; the AI system 202 can make telephone calls to one or more businesses on behalf of a buyer or seller to swap reservations/appointments.

Any type of AI system that can function to make the telephone calls, such as those described above, can be used. One example of an AI system that could be used is the Google Duplex AI system. The AI system 202 that is used should be configured so as to be able to understand human language in the context of a sentence, but also be able to pick up on more complex language context including but not limited to voice fluctuations that determine emotional, sarcastic, or literal intent, matching regional pronunciation and terminology of a language to the correct context, and matching foreign pronunciation to the correct context.

The AI system 202 can place a telephone call to a reservation/appointment based business to see if there are available appointments/reservations for a buyer or seller through a request made via the application 20. The AI system 202 will talk to the business representative on the phone to determine if an available time fits within the user's specified date and time range. If it does, the AI system 202 can make the appointment/reservation on the user's behalf and the user will be notified in the application 20. If no appointments/reservations are available, the application 20 will list reservations/appointments the user can buy from another user in the application as described above.

The use of the AI system 202 will also allow a single user to make multiple calls to reservation/appointment based businesses within a specified category at the same time with a single request made via the application 20. The AI system 20 can then report back to the user, via the application 20, the businesses that have available reservations/appointments at the requested day/time. The user can then use the AI system 202 to complete one or multiple reservations at the same time in the same manner described above.

The systems 10, 200 described herein help create a social trust network among users of the systems 10, 202 by providing a validity of trust to businesses and users (buyers and sellers) of the system during exchanges of reservations/appointments. In one embodiment, a transaction (such as the making of a reservation/appointment or the buying and selling of a reservation/appointment) can be guaranteed if the AI system 202 is making the telephone calls described above.

The systems 10, 200 described herein may also be configured to determine a predicted market value of reservations held or used by the user (including when the user is considered the seller 12, the buyer 14, or the business 16). The predicted market value of the reservations can be based on any factors which can help to determine a market value of the reservations including, but not limited to, previous sale prices of reservations at that restaurant (or other business), the particular restaurant and how popular it is, the day and/or time of the reservation, the geographic location of the restaurant and it's proximity to other restaurants, and the like. In one non-limiting example, the predicted market value can be determined based at least on previous sale prices of reservations at that restaurant. To help explain the concept of predicted market value, assume that based on current sales of reservations at restaurant “A”, from the standpoint of the restaurant the restaurant “A” has a lifetime predicted market value of $52,000 (i.e. a predicted market value of all previous reservations whether used or unused), and a pending predicted market value of $2,300 (i.e. a predicted market value of all current available reservations). From the standpoint of the buyer/seller, user “B” has a current predicted market value of $420 (i.e. the current predicted market value of all reservations held by user “B”) and a lifetime value of $800 (i.e. the predicted market value of all reservation previously held by user “B”). In one embodiment, the predicted market value can be calculated by the server 100.

The predicted market value is then displayed on the user interface. For example, referring to FIG. 4, the predicted market value can be displayed at 62 on the user interface 50. The user interface 50 could be for the seller, the buyer or the restaurant/business.

In another embodiment, the systems 10, 200 described herein may also be configured to alert the user (whether the user is a buyer, seller or restaurant/business), via the mobile device 18, when there is a reservation that is available for purchase that is selling below a predicted market value. For example, assume that a predicted market value of a reservation at restaurant “A” on a particular day and time is currently $100. Also, assume that the system determines that there is a reservation available at restaurant “A” on that particular day and time that is for sale by a user of the system below the predicted market value, for example for $75. The system would then send a signal to the mobile device 18 notifying the user of the available reservation and also informing the user of the deal that is available. For example, the signal sent to the mobile device 18 could cause the mobile device 18 to display, via the user interface 50, one or more of the predicted market value for the reservation at restaurant “A”, the available reservation for sale at restaurant “A” and it's sale price, and/or the deal or savings that would be realized if the user purchased the available reservation at the price below the predicted market value.

In another embodiment, the systems 10, 200 described herein may also be configured to determine a suggested listing price for at least one of the reservations held by a user (for example, the seller). The suggested listing price could be the predicted market value for the one reservation, or the suggested listing price could be based on the predicted market value. The suggested listing price can then be displayed on the user interface, for example, displayed at 62 on the user interface 50 in FIG. 4.

The examples disclosed in this application are to be considered in all respects as illustrative and not limitative. The scope of the invention is indicated by the appended claims rather than by the foregoing description; and all changes which come within the meaning and range of equivalency of the claims are intended to be embraced therein.

1. Application software loaded onto a mobile device that when executed causes the mobile device to:
automatically search the mobile device for a possible reservation;
graphically present the possible reservation to a user via a user interface displayed on a display screen of the mobile device, the user interface further including a selectable option allowing the user to list the possible reservation for sale when the selectable option is selected;
and send the possible reservation from the mobile device to a server when the selectable option is selected.

2. A reservation buying/selling method that is implemented by application software loaded onto a mobile device, the method comprising:
the application software automatically searching the mobile device for a possible reservation;
the application software graphically presenting the possible reservation to a user via a user interface displayed on a display screen of the mobile device, the user interface further including a selectable option allowing the user to list the possible reservation for sale when the selectable option is selected;
the application software sending the possible reservation from the mobile device to a server when the selectable option is selected; and
the application software adding the possible reservation to a list that is displayed on a user interface on the display screen of the mobile device when the selectable option is selected.

3. The reservation buying/selling method of claim 2, further comprising:
determining a predicted market value of reservations held or used by the user, the predicted market value is based at least on previous sale prices of reservations; and
displaying the predicted market value on the user interface.

4. The reservation buying/selling method of claim 2, further comprising:
alerting the user, via the mobile device, when there is a reservation that is available for purchase that is selling below a predicted market value.

5. The reservation buying/selling method of claim 2, further comprising:
determining a suggested listing price for at least one of the possible reservations, and displaying the suggested listing price to the user via the user interface.

6. A mobile device, comprising:
a display screen;
one or more data input devices that allow data entry into the mobile device;
executable application software loaded on the mobile device, the application software when executed searches the mobile device for a possible reservation, graphically presents the possible reservation to a user via a user interface displayed on the display screen, the user interface further including a selectable option allowing the user to list the possible reservation for sale when the selectable option is selected, and sends the possible reservation from the mobile device to a server when the selectable option is selected.

7. A method of locating a reservation using a reservation sell/buy server that is part of a reservation sell/buy system, the method comprising:
the reservation sell/buy server receiving a search request from a buyer's mobile device;
in response to the received search request, the reservation sell/buy server searching past reservations stored on the server, thereafter the reservation sell/buy server searching for present reservations, and thereafter the reservation sell/buy server searching for future reservations stored on the server.
